(19) United States
(12) Patent Application Publication
(10) Pub. No.: US 2019/0266192 A1
(43) Pub. Date: Aug. 29, 2019

(54) ROLE BASED DYNAMIC DATA FILTERING SYSTEM AND METHOD THEREOF

(71) Applicant: Zensar Technologies Ltd., Pune (IN)

(72) Inventors: Jithin VINOD, Malappuram (IN); Sandeep KISHORE, Fremont, CA (US)

(21) Appl. No.: 16/280,519

(22) Filed: Feb. 20, 2019

(30) Foreign Application Priority Data
Feb. 28, 2018 (IN) 201821007566

(51) Int. Cl. G06F 16/9035; G06F 16/951; G06N 5/04

(52) U.S. Cl. CPC G06F 16/9035; G06N 5/04; G06F 16/951

(57) ABSTRACT

The present disclosure relates to the field of data filtering, and envisages a role based dynamic data filtering system and method thereof comprising parser, database, login module, filtration module, converter, prediction module and user device. The parser parses the received data from a plurality of heterogeneous sources. The login module registers a user and authenticates the user based on the registration details entered by the user. The filtration module identifies pre-determined role related data in database based on the extracted role from the registration details, and extracts the identified pre-determined role related data from parsed data based on pre-determined set of filtration rules. The converter converts extracted data into a single format data. The prediction module analyses converted data and historical analysis data, to generate predictions results based on analysed data and pre-determined set of prediction rules.

### CROSS REFERENCE TO RELATED APPLICATIONS

This patent application claims priority from an Indian Provisional Application, filed on Feb. 28, 2018, having application no. 201821007566.

### FIELD

The present disclosure relates to the field of a data filtering system.

### Definitions

As used in the present disclosure, the following terms are generally intended to have the meaning as set forth below, except to the extent that the context in which they are used indicates otherwise.

The expression “organization” used hereinafter in this specification refers to, but is not limited to, an entity generating product or services for the purpose of selling it to a customer.

The expression ‘user’ used hereinafter in the specification refers to an employee of the organization, using the system of the present disclosure.

These definitions are in addition to those expressed in the art.

### BACKGROUND

Organizations usually have diverse and colossal amount of data, created by large number of employees and processes working under different departments of the organizations. This colossal amount of data is usually processed by the organization for making in-house predictions, which helps the top brass in decision making process. Processing such colossal amount of data take substantial time and efforts. However, at an individual employee level, these predictions may not be relevant, because the colossal amount of data used for making predictions may vitiate the prediction making process from the actual factors, which affect the same.

There is, therefore, felt a need to provide a role based dynamic data filtering system that alleviates the above mentioned drawbacks.

### Objects

Some of the objects of the present disclosure, which at least one embodiment herein satisfies, are as follows:

It is an object of the present disclosure to ameliorate one or more problems of the prior art or to at least provide a useful alternative.

An object of the present disclosure is to provide a role based dynamic data filtering system.

Another object of the present disclosure is to provide a role based dynamic data filtering system, which works on online and offline mode.

Yet another object of the present disclosure is to provide a role based dynamic data filtering system, which uses a supervised learning methodology.

Still another object of the present disclosure is to provide a role based dynamic data filtering system, which extracts relevant data from big data.

Other objects and advantages of the present disclosure will be more apparent from the following description, which is not intended to limit the scope of the present disclosure.

### SUMMARY

The present disclosure envisages a role based dynamic data filtering system and a method thereof comprising a parser, a database, a login module, a filtration module, a converter, a prediction module and a user device.

The method for providing predictive results based on role based dynamic data filtering comprising the following steps:
loading historic data into a database;
capturing current data from a plurality of heterogeneous sources, and transferring and storing the captured data into the database;
receiving a request to access the current data, wherein said request is received from a user designated with said role;
verifying said requested data is resident in the database;
analysing the current data, if the requested data is present;
checking the role of the user within a hierarchy;
applying a filter based on the role;
extracting data from the current data based on the filter to obtain filtered data, based on a pre-determined set of filtration rules stored in the database; and
computing predictive results based on a pre-determined set of prediction rules shared in the database after analysing the filtered data with respect to its corresponding historical data and permitting access to the user of the predictive results.

The parser is configured to receive the data from the plurality of heterogeneous sources. The parser is further configured to parse the received data.

The database is configured to cooperate with the parser to store a pre-determined set of filtration rules, a pre-determined set of prediction rules, historical analysis data, the parsed data, registration details associated with a registered user, and a lookup table having a role related to each registered user and corresponding pre-determined role related data.

The login module is configured to cooperate with the database to register at least one user and store the registration details in the database, to authenticate at least one registered user.

The filtration module is configured to cooperate with the database to extract the role of the registered user based on the stored registration details, to identify the pre-determined role related data in the lookup table based on the extracted role. The filtration module extracts the identified pre-determined role related data from the parsed data based on the pre-determined set of filtration rules.

The converter is configured to cooperate with the filtration module to convert the extracted data into a single format data.

The prediction module is configured to cooperate with the converter and the database, to analyse the converted data and the historical analysis data. The prediction module is configured to generate predictions results based on the analysed data and the pre-determined set of prediction rules.

In an embodiment, the login module, the filtration module, the converter, and the prediction module are implemented using one or more processor(s).

The login module includes a registration module, and an authentication module. The registration module is configured to receive the registration details from the user, to store the registration details in the database. The authentication module is configured to cooperate with the database to receive the registration details from the user. The authentication module further comprises a comparator to compare the received registration details of the user with the stored registration details of the user in the database.

The filtration module includes a first crawler and extractor, a second crawler and extractor and a third crawler and extractor. The first crawler and extractor is configured to cooperate with the login module and the database, to identify the role of the registered user from the registration details. The first crawler and extractor is further configured to extract the role associated to the registered user. The second crawler and extractor is configured to cooperate with the first crawler and extractor and the database to crawl the lookup table based on the extracted role and identify the extracted role. The second crawler and extractor is configured to extract the pre-determined role related data. The third crawler and extractor is configured to cooperate with the second crawler and extractor and the database to crawl through the parsed data and extract the identified pre-determined role related data, based on the pre-determined set of filtration rules.

The prediction module includes an analyser configured to cooperate with the converter and the database, to analyse the converted data and the historical analysis data. The analyser is further configured to generate the analysed data.

The prediction module is configured to generate prediction results based on Artificial Intelligence (AI).

The user device is configured to cooperate with the prediction module to receive the prediction results and the prediction results are displayed in the form of graphs, text, or videos.

The user provides the registration details to request access to said current data, wherein said registration details are selected from the group of name, designation, department, rank, role, login credential, and email id, to request access to the current data.

In an embodiment, multi-format data of the extracted data is converted into a single format data which is configured to occupy less space in the database.

### BRIEF DESCRIPTION OF THE ACCOMPANYING DRAWING

A role based dynamic data filtering system and a method thereof, of the present disclosure will now be described with the help of the accompanying drawing, in which:

FIG. 1 illustrates a schematic block diagram of a role based dynamic data filtering system, in accordance with an embodiment of the present disclosure; and

FIGS. 2a and 2b illustrate a flowchart of a method for role based dynamic data filtering.

### LIST AND DETAILS OF REFERENCE NUMERALS USED IN THE DESCRIPTION AND DRAWING

| Reference Numeral | Reference |
|---|---|
| 100 | System |
| 10 | Database |
| 15 | Parser |
| 20 | Login module |
| 22 | Registration module |
| 24 | Authentication module |
| 26 | Comparator |
| 30 | Filtration module |
| 32 | First crawler and extractor |
| 34 | Second crawler and extractor |
| 36 | Third crawler and extractor |
| 40 | Converter |
| 50 | Prediction module |
| 55 | Analyser |
| 60 | User device |

### DETAILED DESCRIPTION

Embodiments, of the present disclosure, will now be described with reference to the accompanying drawing.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

The terms first, second, third, etc., should not be construed to limit the scope of the present disclosure as the aforementioned terms may be only used to distinguish one element, component, region, layer or section from another component, region, layer or section. Terms such as first, second, third etc., when used herein do not imply a specific sequence or order unless clearly suggested by the present disclosure.

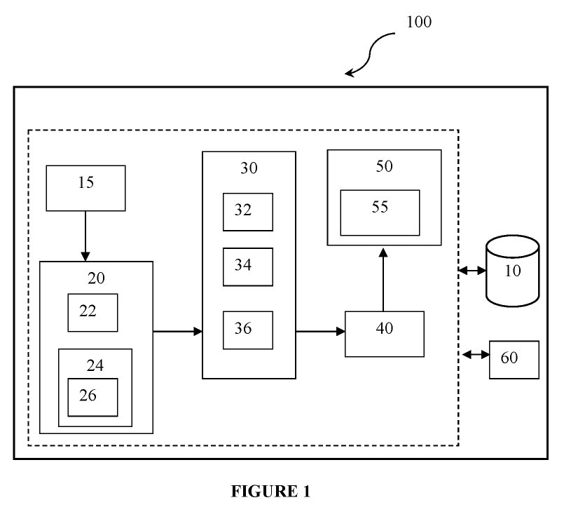

A role based dynamic data filtering system, of the present disclosure is described with reference to FIG. 1 of accompanying drawings.

A role based dynamic data filtering system (100), is configured to store data received from a plurality of heterogeneous sources in at least one database (10), analyse the received data and historical analysis data stored in at least one database (10), compute predictive results based on pre-determined set of prediction rules stored in the database (10) and analysis performed earlier, and permit each of the plurality of users to access the predictive results based on role of a user in a hierarchy.

A system (100) for providing predictive results based on role based dynamic data filtering (hereinafter referred to as system) comprises a parser (15), a database (10), a login module (20), a filtration module (30), a converter (40), a prediction module (50) and a user device (60).

The parser (15) is configured to receive the data from plurality of heterogeneous sources. The parser (15) is configured to parse the received data.

In an embodiment, the heterogeneous sources can be emails, social media platforms, website performance, press release, user's interaction with the emails, social media platforms, website, and press publication. The key email metrics such as opens, clicks, delivered, and bounced are tracked using the market automation platforms to generate email related data. The key social media metrics such as likes, followers, shares, engaged, and posts are tracked to generate social media related data. In an embodiment, third party analytical tools are used to track the website metrics.

The database (10) is configured to cooperate with the parser (15) to store a pre-determined set of filtration rules, the pre-determined set of prediction rules, the historical analysis data, the parsed data, registration details associated with a registered user, and a lookup table having a role related to each registered user and corresponding pre-determined role related data.

The login module (20) is configured to cooperate with the database (10) to register at least one user and store the registration details in the database (10). The login module (20) is configured to authenticate at least one registered user.

The login module (20) includes a registration module (22) and an authentication module (24). The registration module (22) is configured to receive the registration details from the user. The registration module (22) is further configured to store the registration details in the database (10).

The user provides the registration details to request access to said current data, wherein said registration details are selected from the group of name, designation, department, rank, role, login credential, and email id, to request access to the current data. The user requests to access the current data, based on the designated role.

The authentication module (24) is configured to cooperate with the database (10) to receive the registration details from the user. The authentication module (24) further comprises a comparator (26) to compare the received registration details of the user with the stored registration details of the user in the database (10).

An exemplified pseudocode for the login module (20) is given below:

Program (login module)

Read registration details from the user.
Compare the received registration details
of the user with the stored registration details
of the user in the database.

End

The filtration module (30) is configured to cooperate with the database (10) to extract the role of the registered user based on the stored registration details. The filtration module (30) is further configured to identify the pre-determined role related data in the lookup table based on the extracted role, and to extract the identified pre-determined role related data from the parsed data based on the pre-determined set of filtration rules.

The filtration module (30) includes a first crawler and extractor (32), a second crawler and extractor (34), and a third crawler and extractor (36).

The first crawler and extractor (32) is configured to cooperate with the login module (20) and the database (10), to identify the role of the registered user from the registration details. The first crawler and extractor (32) is further configured to extract the role associated to the registered user.

The second crawler and extractor (34) is configured to cooperate with the first crawler and extractor (32) and the database (10) to crawl the lookup table based on the extracted role and identify the extracted role. The second crawler and extractor (34) is configured to extract the pre-determined role related data.

The third crawler and extractor (36) is configured to cooperate with the second crawler and extractor (34) and the database (10) to crawl through the parsed data and extract the identified pre-determined role related data, based on the pre-determined set of filtration rules.

An exemplified pseudocode for the filtration module (30) is given below:

Program (filtration module)

Do {
extract the role of the registered user
based on the stored registration details.
identify the pre-determined role related
data in the lookup table based on the extracted
role.
extract the identified pre-determined role
related data from the parsed data based on the
pre-determined set of filtration rules.
while (reading registration details)

End

The converter (40) is configured to cooperate with the filtration module (30) to convert the extracted data that includes multi-format data into a single format data which is configured to occupy less space in the database.

An exemplified pseudocode for the filtration module (30) is given below:

Program (converter)

convert the extracted data into a single format data.

End

The prediction module (50) is configured to cooperate with the converter (40) and the database (10), to analyse the converted data and the historical analysis data. The prediction module (50) is further configured to generate predictions results based on the analysed data and the pre-determined set of prediction rules.

The prediction module (50) includes an analyser (55). The analyser (55) is configured to cooperate with the converter (40) and the database (10), to analyse the converted data and the historical analysis data, and generate the analysed data.

An exemplified pseudocode for the prediction module (50) is given below:

Program (prediction)

Do {
analyse the converted data and the historical analysis data.
generate predictions results based on analysed data and the
pre-determined set of
prediction rules.}
While (reading converted data and the historical analysis data)

End

In an embodiment, the prediction module (50) is configured to generate prediction results based on Artificial Intelligence (AI).

The user device (60) is configured to cooperate with the prediction module (50) to receive the prediction results.

In another embodiment, the prediction results are displayed in the form of graphs, text, or videos.

In yet another embodiment, the user device (60) is selected from the group, not limited to, consisting of handheld device, smart phone, kiosk, laptop, desktop, palmtop, iPad, and tablet.

The parser (15), login module (20), filtration module (30), converter (40), and prediction module (50), are implemented using one or more processor(s).

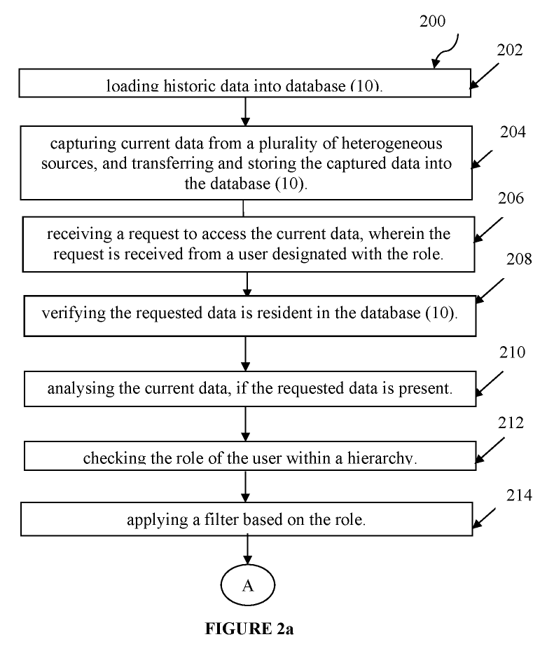

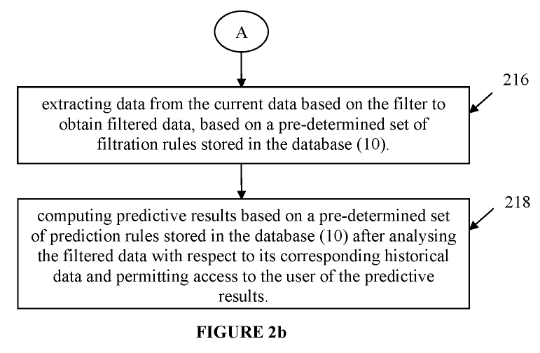

FIGS. 2a and 2b illustrate a flowchart of a method for role based dynamic data filtering.
Step 202: loading historic data into a database (10).
Step 204: capturing current data from a plurality of heterogeneous sources, and transferring and storing the captured data into the database (10).
Step 206: receiving a request to access the current data, wherein the request is received from a user designated with the role.
Step 208: verifying the requested data is resident in the database (10).
Step 210: analysing the current data, if the requested data is present.
Step 212: checking the role of the user within a hierarchy.
Step 214: applying a filter based on the role.
Step 216: extracting data from the current data based on the filter to obtain filtered data, based on a pre-determined set of filtration rules stored in the database (10).
Step 218: computing predictive results based on a pre-determined set of prediction rules stored in the database (10) after analysing the filtered data with respect to its corresponding historical data and permitting access to the user of the predictive results.

### Technical Advancements

The present disclosure described herein above has several technical advantages including, but not limited to, the realization of a role based dynamic data filtering system, which:
works on online and offline mode;
uses supervised learning methodology; and
extracts relevant data from big data.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully revealed the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A method for providing predictive results based on role based dynamic data filtering comprising the following steps:
loading historic data into a database (10);
capturing current data from a plurality of heterogeneous sources, and transferring and storing said captured data into said database (10);
receiving a request to access said current data, wherein said request is received from a user designated with said role;
verifying said requested data is resident in said database (10);
analysing said current data, if said requested data is present;
checking said role of said user within a hierarchy;
applying a filter based on said role;
extracting data from said current data based on said filter to obtain filtered data, based on a pre-determined set of filtration rules stored in said database (10); and
computing predictive results based on a pre-determined set of prediction rules stored in said database (10) after analysing said filtered data with respect to its corresponding historical data and permitting access to said user of said predictive results.

2. A system (100) for providing predictive results based on role based dynamic data filtering, said system (100) comprising:
a parser (15) configured to receive said data from a plurality of heterogeneous sources, said parser (15) configured to parse said received data;
a database (10) configured to cooperate with said parser (15) to store a pre-determined set of filtration rules, a pre-determined set of prediction rules, historical analysis data, said parsed data, registration details associated with a registered user, and a lookup table having a role related to each registered user and corresponding pre-determined role related data;
a login module (20) configured to cooperate with said database (10) to register at least one user and store said registration details in said database (10), said login module (20) further configured to authenticate at least one registered user;
a filtration module (30) configured to cooperate with said database (10) to extract said role of said registered user based on said stored registration details, said filtration module (30) further configured to identify said pre-determined role related data in said lookup table based on said extracted role, further configured to extract said identified pre-determined role related data from said parsed data based on said pre-determined set of filtration rules;
a converter (40) configured to cooperate with said filtration module (30) to convert said extracted data into a single format data; and
a prediction module (50) configured to cooperate with said converter (40) and said database (10), said prediction module (50) configured to analyse said converted data and said historical analysis data, further configured to generate predictions results based on said analysed data and said pre-determined set of prediction rules,
wherein said parser (15), said login module (20), said filtration module (30), said converter (40), and said prediction module (50) are implemented using one or more processor(s).

3. The system (100) as claimed in claim 2, wherein said login module (20) includes:
a registration module (22) configured to receive said registration details from said user, said registration module (22) further configured to store said registration details in said database (10); and
an authentication module (24) configured to cooperate with said database (10) to receive said registration details from said user, said authentication module (24) further comprises a comparator (26) to compare said received registration details of said user with said stored registration details of said user in said database (10).

4. The system (100) as claimed in claim 2, wherein said filtration module (30) includes:
a first crawler and extractor (32) configured to cooperate with said login module (20) and said database (10), to identify said role of said registered user from said registration details, said first crawler and extractor (32) further configured to extract said role associated to said registered user;
a second crawler and extractor (34) configured to cooperate with said first crawler and extractor (32) and said database (10) to crawl said lookup table based on said extracted role and identify said extracted role, said second crawler and extractor (34) configured to extract said pre-determined role related data; and
a third crawler and extractor (36) configured to cooperate with said second crawler and extractor (34) and said database (10) to crawl through said parsed data and extract said identified pre-determined role related data, based on said pre-determined set of filtration rules.

5. The system (100) as claimed in claim 2, wherein said prediction module (50) includes:
an analyser (55) configured to cooperate with said converter (40) and said database (10), to analyse said converted data and said historical analysis data, said analyser (55) further configured to generate said analysed data.

6. The system (100) as claimed in claim 5, wherein said prediction module (50) is configured to generate prediction results based on Artificial Intelligence (AI).

7. The system (100) as claimed in claim 6, wherein user device (60) is configured to cooperate with said prediction module (50) to receive said prediction results.

8. The system (100) as claimed in claim 7, wherein said prediction results are displayed in the form of graphs, text, or videos.

9. The method as claimed in claim 1, wherein said user provides said registration details to request access to said current data, wherein said registration details are selected from the group comprising name, designation, department, rank, role, login credential, and email id.

10. The method as claimed in claim 1 includes a step of converting multi-format data into a single format data which is configured to occupy less space in said database (10).
